(19) United States
(12) Patent Application Publication
(10) Pub. No.: US 2014/0288851 A1
(43) Pub. Date: Sep. 25, 2014

(54) METHOD FOR SEQUENCE RECOMBINATION AND APPARATUS FOR NGS

(71) Applicant: SAMSUNGSDS CO., LTD., Seoul (KR)

(72) Inventors: Min Seo Park, Seoul (KR); Pan Gyu Kim, Seoul (KR)

(73) Assignee: SAMSUNG SDS CO., LTD., Seoul (KR)

(21) Appl. No.: 14/355,434

(22) PCT Filed: Sep. 11, 2012
(86) PCT No.: PCT/KR2012/007273

§ 371 Date: Apr. 30, 2014

(30) Foreign Application Priority Data
Oct. 31, 2011 (KR) 10-2011-0112370

(51) Int. Cl. G06F 19/22

(52) U.S. Cl. CPC G06F 19/22
USPC 702/20

(57) ABSTRACT

Provided are a sequence recombination method for NGS and an apparatus thereof. According to an embodiment of the present, a fragment sequence having a length of n is divided into six fragments of an equal sequence length, and then three fragments located in a preceding part of the fragment sequence among the six fragments of an equal sequence length are used as a seed to search for a mapping position candidate by searching for a hash table which is generated on the basis of a reference sequence.

### CROSS-REFERENCE TO RELATED APPLICATION

This application is a National Stage application under 35 U.S.C. §371 of PCT/KR2012/007273, filed on Sep. 11, 2012, which claims priority from Korean Patent Application No. 10-2011-0112370, filed on Oct. 31, 2011, all the disclosures of which are incorporated herein in their entireties by reference.

### BACKGROUND

1. Field

The present invention relates to sequencing in which entire gene sequence of a biological subject is completed. More specifically, the present invention relates to indexing and search technology to perform a fragment sequence recombination for next generation sequencing (NGS).

2. Description of the Related Art

The core of genome sequencing, which is decoding of DNA sequence information, is to investigate differences among individuals and characteristics of different ethnic groups, to identify congenital causes of diseases related to genetic abnormalities including chromosome abnormality, and to search for a genetic defect in complex diseases such as diabetes and hypertension.

In addition, sequencing data are very important because the information about gene expression, genetic diversity, genetic variation, genetic causes of disease, and interaction thereof may be extensively used for molecular diagnosis and treatment.

Sanger's sequencing method of producing a long sequence, which has been traditionally used in genetic studies, is rapidly substituted by NGS technology for producing a short sequence, since the NGS technology is superior to Sanger's sequencing method with respect to the time and cost consumed in the experimental procedure and the applicability. In addition, various NGS sequence recombination software programs focused on accuracy have been developed.

Recently, the NGS cost has been decreased to a level 1/1,520,000 of that of the past human genome project (HGP) and thereby the amount of data which may be used as a short sequence has been increased. Methods such as Short Oligonucleotide Alignment Program 2 (SOAP2) have been developed as a method of processing mass data. However, while SOAP2 shows a rapid processing speed with particular sequence lengths, the sequence quality is not guaranteed. Therefore, there is an increasing demand for rapid processing of mass sequences of a short length while the processing method maintains good sequence quality.

### SUMMARY

The present invention provides an indexing method and a searching method for recombining short fragment sequences obtained from a sequencer, while ensuring the sequence quality, and for producing a single entire base sequence.

According to an aspect of the present invention, there is provided a sequence recombination method for NGS including dividing a fragment sequence having a length of n into six fragments of an equal sequence length; forming a hash table by generating a hash value of a reference sequence for each of sub-strings of n/6 size; using as a seed each of three fragments located in a preceding part of the fragment sequence among the six fragments of an equal sequence length; calculating a hash values of the three seeds; and searching for a mapping position candidate by searching from the hash table for a hash value which coincides with a hash value of the three seeds.

An embodiment of the present invention includes a dividing part dividing a fragment sequence having a length of n into six fragments of an equal sequence length; a seed-generating part using as a seed each of three fragments located in a preceding part of the fragment sequence among the six fragments of an equal sequence length; a hash value-generating part calculating a hash values of the three seeds; a hash table-generating part generating a hash value of a reference sequence for each of sub-strings of n/6 size; and a searching part searching from the hash table for a hash value which coincides with a hash value of the three seeds.

The present invention may guarantee sequence quality and improve sequencing speed when short fragment sequences obtained from a sequencer are recombined to form a base sequence.

The sequence recombination method and the apparatus for NGS of the present invention may be used to reduce the time for completing an entire genome sequence from blood test results and to enable rapid genome analysis during a disease diagnosis so that the time for identifying a genetic cause of a disease may be reduced.

### DESCRIPTION OF THE DRAWINGS

The above and other features will become more apparent by describing in detail exemplary embodiments thereof with reference to the attached drawings in which:

FIG. 1 shows a flow chart of recombining sequence data to complete a genomic sequence;

FIG. 2 shows a general block diagram of a genome analysis solution;

FIG. 3 shows an embodiment of a conventional MAO indexing method;

FIG. 4 shows an example of generating a hash table on the basis of a genome reference sequence according to an embodiment of the present invention;

FIG. 5 shows a method of sequence recombination for NGS according to an embodiment of the present invention; and

FIG. 6 shows a block diagram of a sequence recombination apparatus for NGS according to an embodiment of the present invention.

### DETAILED DESCRIPTION

Hereinafter, the present invention will be described in further detail with reference to examples. It should be noted that like reference numerals designate like elements although they are shown in different drawings.

In the description of the present invention below, when it is determined that the detailed description of the related art would obscure the gist of the present invention, the description thereof will be omitted.

In addition, it is clearly mentioned that modification and alterations can be made by those skilled in the art without departing from the spirit and scope of the invention.

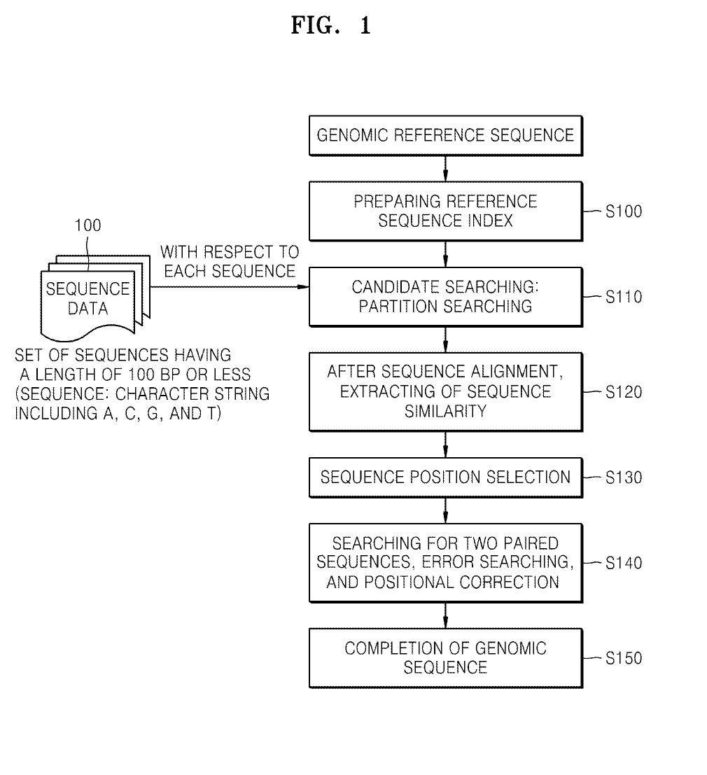

FIG. 1 shows a flow chart of recombining sequence data to complete a genomic sequence.

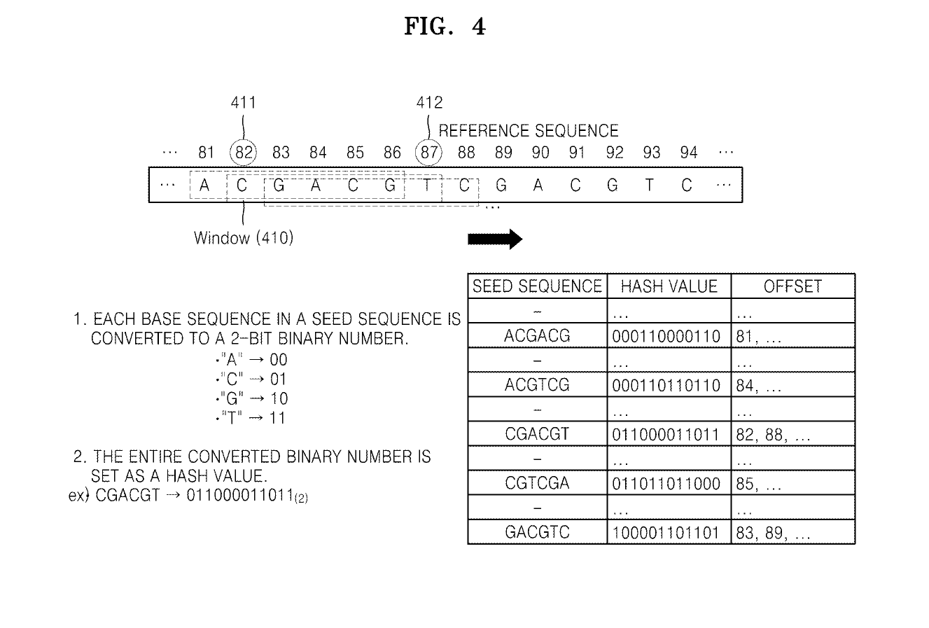

An index of genomic reference sequences is prepared (S110). According to an embodiment of the present invention, to prepare the index, a hash table is formed by generating a hash value of a genomic reference sequence for each of sub-strings of n/6 size. Herein, “n” represents the length of the input sequence data 100. An example of generating a hash value for each of sub-strings of n/6 size is shown in FIG. 4.

According to an embodiment of the present invention, the sequence data 100 represents a sequence group which is a character string of 100 base pairs or less including A, G, C, and T.

Then, after dividing the sequence data 100 into six fragments of an equal sequence length, each of three fragments located in a preceding part of the fragment sequence among the six fragments of an equal sequence length is used as a seed and then a hash value is generated for the three seeds. After the hash values of the seeds are generated, a hash value which coincides with a hash value of the three seeds is searched from the hash table to search for a mapping position candidate (S110). An example of a method of generating a hash value and forming a hash table is shown in FIG. 4.

After a mapping position candidate is searched, the sequence data 100 and a corresponding position of the reference sequence are aligned without a gap to measure similarity (S120). This work is performed for all the searched mapping position candidates, and then a position having a highest similarity is selected as an optimum position (S130). Then, two sequences forming a pair are searched and error search and positional correction are performed to complete a genomic sequence (S140, S150).

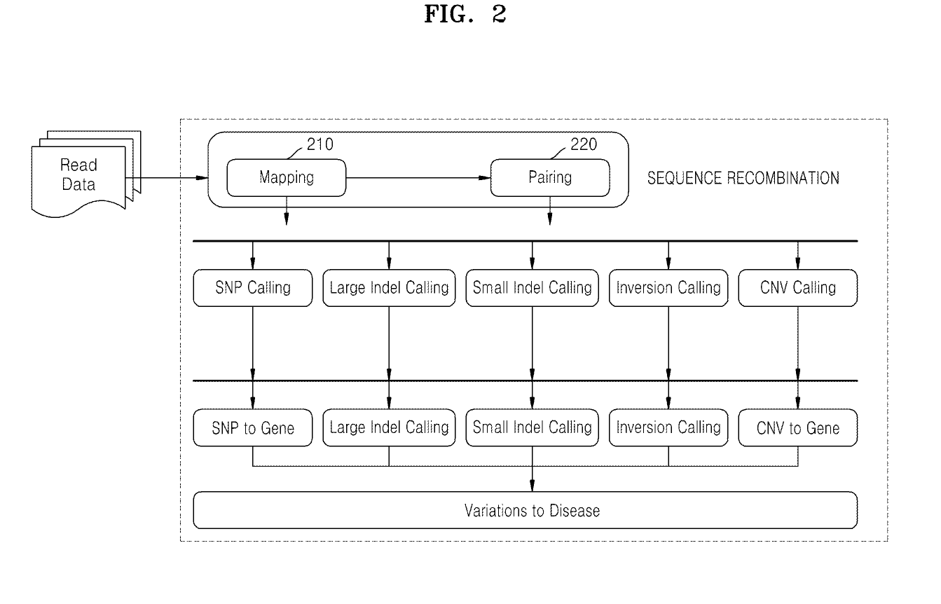

FIG. 2 shows a general block diagram of a genome analysis solution.

A genome analysis solution is a process needed for all studies and implementations of all Bio/Medical Informatics and is used in sequencing area in which entire genetic sequences of a biological subject, in analysis area in which relationship among genetic variations are analyzed, in medical area in which genetic sequences causing a genetic disease are identified, and pharmaceutical area in which proteins and genetic sequences with which a specific chemical reacts are identified.

According to an embodiment of the present invention, in mapping 210 and pairing 220, which are corresponding to pretreatment of a genomic analysis solution, a conventional mapping and assembly with quality (MAQ) indexing method is improved and used.

The conventional MAQ was a tool which may deal with not only a genome analyzer but also a SOLiD fragment sequence and performed mapping in a unit of a fragment sequence. In addition, six seeds were used for mapping in which two seeds were paired.

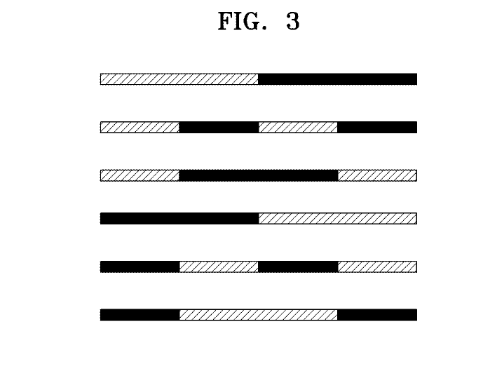

FIG. 3 shows an embodiment of a conventional MAQ indexing method.

As shown in FIG. 3, while the conventional MAQ allows for up to k mismatches, MAQ divides each fragment sequence to k or more fragments. For example, when two mismatches are allowed for a fragment sequence having a length of 28, the fragment sequence is divided into four (>k=2) fragments, combination seeds are generated by combining seeds by two, and six hash values are generated on the basis of the combination seeds to create a hash table. A reference sequence is scanned in order and, when at least one among the six seeds is found, an accurate alignment score is calculated to decide whether to perform mapping or not.

However, in the present invention, MAQ may be used to perform mapping in a unit of a seed. In addition, the number of used seeds has been reduced to three so that the time may be reduced by at least 50% in comparison with the time take by the conventional MAQ method.

In the conventional MAQ, a standard pattern was used for seed combination and six non-continuous seeds were used and thus the speed was low. However, according to an embodiment of the present invention, the present invention employs three seeds and each seed is used independently so that a parallel processing may be performed with an improved speed.

FIG. 4 shows an example of generating a hash table on the basis of a genome reference sequence according to an embodiment of the present invention.

When a fragment sequence having a length of n is entered, a hash table of a genomic reference sequence may be generated as shown in FIG. 4. Moving from the offset of the reference sequence by one sequence at each time, a seed sequence field 420 including a sub-string such as ACGACG, CGACGT, GACGTC . . . is generated. Then, a hash value field 430 for each sub-string is generated, and a hash table including an offset field 440 in which an offset of each seed sequence is recorded is generated.

According to an embodiment of the present invention, a hash value is generated as one value for each sub-string in the seed sequence field 420. A hash value is generated by substituting each of base sequences, which are A, C, G, and T, with a 2-bit binary number, 00, 01, 10, and 11, respectively. For example, CGACGT is converted to a hash value which is 011000011011. For the CGACGT sub-string, 011000011011 is generated in a hash value field and 82(411), 88(412), . . . are generated in an offset filed in a hash table 450.

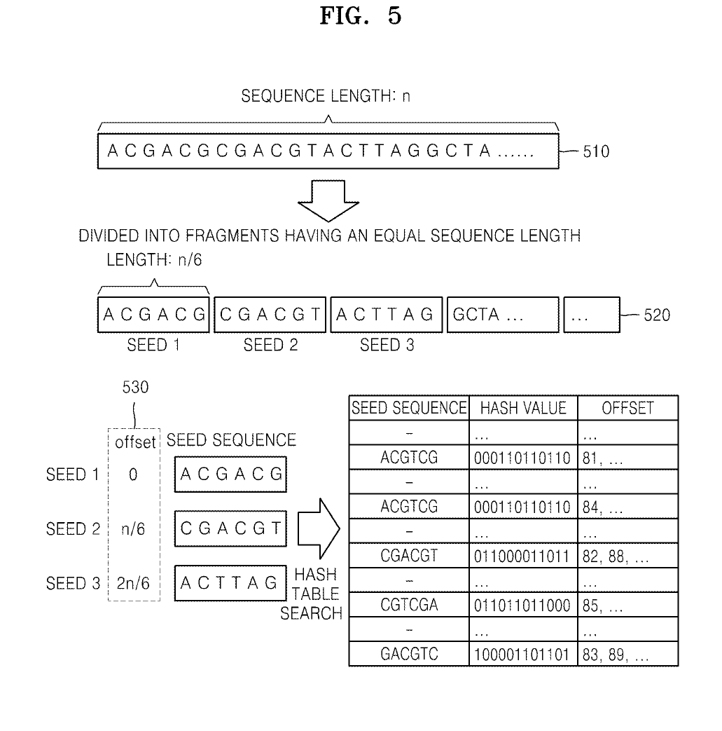

FIG. 5 shows a method of sequence recombination for NGS according to an embodiment of the present invention.

A fragment sequence having a sequence length of n 510 is divided into six fragments of an equal sequence length. Among the six fragments, three preceding fragments are used as seeds 520. The reason why only three preceding fragments in a fragment sequence 510 are used according to an embodiment of the present invention is that accuracy is lower in a latter part of a fragment sequence and is higher in the former base sequence.

With respect to the three seeds generated by the method described above, an offset 530 for each seed is stored. According to an embodiment of the present invention, an offset of a seed is set up with reference to a starting point of a fragment sequence 510. An offset of a first seed (Seed 1) is stored as 0, that of a second seed (Seed 2) is stored as n16, and that of a third seed (Seed 3) is stored as 2n/6.

In addition, a hash value is generated for the three generated seeds. Then, in a hash table such as the one shown in FIG. 4, a mapping position candidate having a sequence the same as each seed is searched within O(1) searching time. Big “O” notaion is commonly used to express the time complexity of an algorithm which quantifies the amount of time taken by an algorithm to run as a function of the length of the string representing the input.

When searching is performed by using the method presented above according to an embodiment of the present invention, searching is performed with respect to only three seeds and thereby the searching time may be reduced to half or less of the searching time taken in a conventional method.

When mapping position candidates are searched, the entire fragment sequence entered in each mapping position candidate and the corresponding position in the reference sequence are aligned by Smith-Waterman algorithm to measure similarity. After measuring similarity at all the searched mapping position candidates, a position having the highest similarity is assigned as an optimum position and arranged.

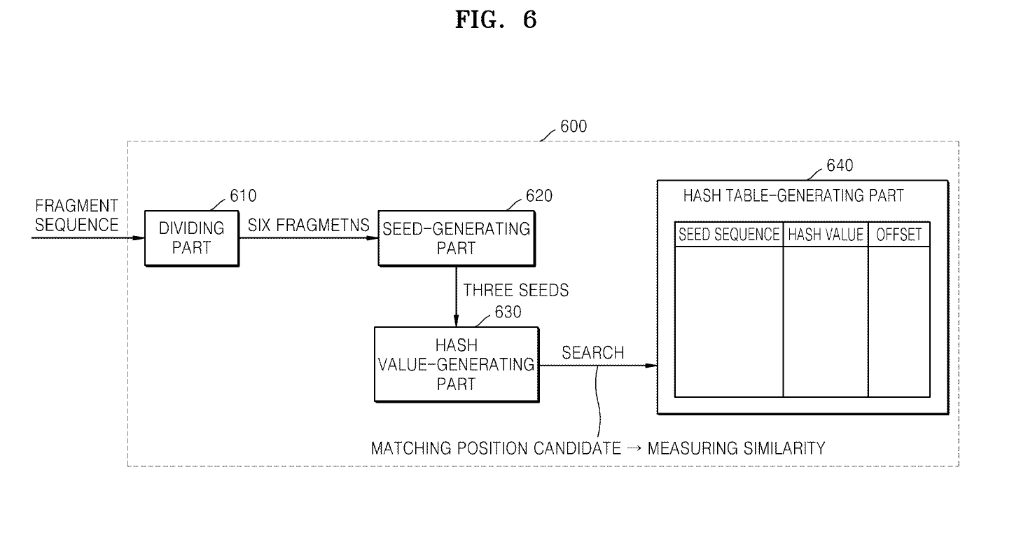

FIG. 6 shows a block diagram of a sequence recombination apparatus for NGS according to an embodiment of the present invention.

A sequence recombination apparatus for NGS 600 includes a dividing part 610, a seed-generating part 620, a hash value-generating part 630, a hash table-generating part 640m and a searching part 650.

The dividing part divides a fragment sequence having a length of n into six fragments of an equal sequence length. According to an embodiment of the present invention, when a fragment sequence is divided into six fragments of an equal sequence length, an optimum speed may be supported with quality.

A case in which a fragment sequence is divided into five fragments of an equal sequence length is compared below with a case in which a fragment sequence is divided into six fragments of an equal sequence length.

1) A case in which a fragment sequence is divided into five fragments of an equal sequence length:

When a maximum length of a fragment sequence is 100 bp, the memory required for each seed is 10 bytes.

Seed sequence: 0 byte (reversely converted to a hash value)

Hash value: 5 byte (4²⁰=2^{(8*5)})

Offset: 5 byte

chromosome#: 1 byte (23<2⁸)

offset: 4 byte (240,000,000<2^{(8*4)})

Hash table size: 10 TB

10 bytes*4²⁰=10*(2̂³⁰)*2̂¹⁰=10 GB*2̂¹⁰=10 TB

When a fragment sequence is divided into five fragments of an equal sequence length, 10 TB is needed for a hash table, as shown above.

2) A case in which a fragment sequence is divided into six fragments of an equal sequence length:

When a maximum length of a fragment sequence is 100 bp, the memory required for each seed is 9 bytes.

Seed sequence: 0 byte (reversely converted to a hash value)

Hash value: 4 byte (4¹⁵=2^{(8*4)})

Offset: 5 byte

chromosome#: 1 byte (23<2⁸)

offset: 4 byte (240,000,000<2^{(8*4)})

Hash table size: 9 Gbytes

9 bytes*4¹⁵=9*(2̂³⁰)=9 GB

When a fragment sequence is divided into five fragments of an equal sequence length, 9 GB is needed for a hash table, as shown above.

The searching part 650 searches from the hash table for a hash value which coincides with a hash value of the three seeds to search for a mapping position candidate. A hash table includes a seed sequence field which includes sub-strings having a size of n/6, a hash value field in which a hash value for each sub-string is recorded, and an offset field in which an offset field of each sub-string is recorded.

The present invention can also be implemented through computer readable code in/on a computer readable medium. The medium can correspond to any medium/media permitting the storage and/or transmission of the computer readable code.

Examples of computer readable code include ROM, RAM, CD-ROM, magnetic tape, floppy disks, and optical recording media. In addition, a computer readable medium may also be a distributed network, so that the computer readable code is stored/transferred and executed in a distributed fashion.

Hereinbefore, some preferable embodiments are disclosed in the drawings and the description. Here, although specified terms are used, they are only used for describing the objective of the invention but not for limiting the definition or the scope of the invention written in the claims.

Accordingly, those skilled in the art shall understand that various modifications and other equivalent examples can be implemented according to the above examples. Therefore, the technical scope, required to be protected in the invention, shall depend on the technical thoughts of claims attached.

1. A method of performing sequence recombination for next generation sequencing (NGS), the method comprising:
dividing a fragment sequence having a length of n into six fragments having an equal sequence length;
providing a hash table including a hash value for each of sub-strings of a reference sequence, the each of sub-strings having a size of n/6;
determining, as a first to a third seeds, three fragments among the six fragments according to a location thereof in the fragment sequence;
calculating hash values of the first to third seeds; and
determining a mapping position candidate by searching from the hash table for a hash value which matches with at least one of the hash values of the first to third seeds.

2. The method of claim 1, wherein an offset of a seed is determined according to a starting point of the fragment sequence, and an offset of the first seed is a position 0, an offset of a second seed is a position n/6, and an offset of the third seed is a position 2n/6.

3. The method of claim 1, wherein the providing comprises providing the hash table including the hash value generated by substituting nucleobases adenine (A), guanine (G), cytosine (C), and thymine (T) included in the each of sub-strings with binary numbers “00”, “01”, “10”, and “11”, respectively.

4. The method of claim 1, wherein, in the determining, the searching is performed for each of the first to third seeds within substantially searching time of O(1).

5. The method of claim 1, wherein, the determining comprises substantially simultaneously searching the first to third seeds in parallel.

6. The method of claim 1, wherein the hash table comprises a seed sequence field comprising the each of sub-strings having a size of n/6, a hash value field in which the hash value for the each of sub-strings is recorded, and an offset field in which an offset of the each of sub-strings is recorded.

7. The method of claim 1, further comprising measuring similarity by aligning an entire fragment sequence entered in each mapping position candidate and a corresponding position in the reference sequence.

8. An apparatus for performing sequence recombination for next generation sequencing (NGS), the apparatus comprising:
a dividing part configured to divide a fragment sequence having a length of n into six fragments having an equal sequence length;
a seed-generating part configured to determine, as a first to a third seeds, three fragments among the six fragments according to a location thereof in the fragment sequence;
a hash value-generating part configured to calculate hash values of the first to third seeds;
a hash table-generating part configured to generate a hash table including a hash value for each of sub-strings of a reference sequence, the each of sub-strings having a size of n/6; and
a searching part configured to search from the hash table for a hash value which matches with at least one of the hash values of the first to third three seeds.

9. The apparatus of claim 8, wherein an offset of a seed is determined according to a starting point of the fragment sequence, and an offset of the first seed is a position 0, an offset of a second seed is a position n/6, and an offset of the third seed is a position 2n/6.

10. The apparatus of claim 8, wherein the hash value is generated by substituting nucleobases adenine (A), guanine (G), cytosine (C), and thymine (T) included in the each of sub-strings with binary numbers “00”, “01”, “10”, and “11”, respectively.

11. The apparatus of claim 8, wherein, the searching part performs searching for each of the first to third seeds within substantially searching time of O(1).

12. The apparatus of claim 8, wherein the searching part substantially simultaneously searches the first to third seeds in parallel.

13. The apparatus of claim 8, wherein the hash table comprises a seed sequence field comprising the each of sub-strings having a size of n/6, a hash value field in which the hash value for the each of sub-strings is recorded, and an offset field in which an offset of the each of sub-strings is recorded.

14. The apparatus of claim 8, wherein the searching part measures similarity by aligning an entire fragment sequence entered in each mapping position candidate and a corresponding position in the reference sequence.
